(19) United States
(12) Patent Application Publication
(10) Pub. No.: US 2003/0148906 A1
(43) Pub. Date: Aug. 7, 2003

(54) Stable liquid or gel bleaching composition containing diacyl peroxide particles

(75) Inventors: Elizabeth Ann Alam, West Chester, OH (US); Marie Rose Salem, Cincinnati, OH (US); Leslie Dawn Waits, Cincinnati, OH (US); Brian Xiaoqing Song, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/349,734

(22) Filed: Jan. 23, 2003

Related U.S. Application Data
(63) Continuation of application No. 09/846,962, filed on May 1, 2001, now abandoned.

(51) Int. Cl. B08B 7/00; B08B 9/20; B08B 3/14; B08B 3/00; C11D 1/00; C23G 1/00

(52) U.S. Cl. 510/221; 134/25.2; 510/218; 510/235; 510/220; 510/245

(57) ABSTRACT

Liquid or gel bleaching compositions comprising a diacyl peroxide, thickener, and water are disclosed. Preferred compositions are for use in automatic dishwashing machines. The compositions are effective in removing stains, especially carotenoid stains, from plastics while minimizing deposition.

### TECHNICAL FIELD

The present invention relates to stable liquid or gel bleaching compositions that provide enhanced cleaning, especially improved stain removal on plastic surfaces, while minimizing filming and deposition when used in an automatic dishwashing machine. The compositions comprise small diacyl peroxide particles suspended in an aqueous system where they remain insoluble.

### BACKGROUND OF THE INVENTION

Stabilizing peroxygen bleaching agents in liquid and gel products is more difficult to achieve than in granular formulations. This is particularly true for diacyl peroxides (DAPs). As a consequence, there has been a substantial amount of research to develop DAP bleaching systems effective in various liquid or gel formulations.

WO 95/19132, published Jul. 20, 1995, discloses diacyl and tetraacyl peroxides to inhibit the transfer of bleachable food soils from an aqueous wash solution to a substrate during the dishwashing process, and to enhance removal of bleachable food soils from plastic substrates.

EP 717,102, published Jun. 19, 1996, discloses alkaline liquid detergent compositions containing diacyl peroxide, solvent and chelant. The preferred diacyl peroxides have a particle size of greater than 10 microns, preferably from about 100 microns to about 2000 microns, more preferably from about 500 microns to 1000 microns. The solvent is selected to have a solubility parameter value outside about ±4 of the diacyl peroxide's solubility parameter. The compositions are preferably used as automatic dishwashing detergents, and are effective at removing stains, especially carotenoid, from plastics.

It has now been discovered that stable liquid or gel bleaching compositions containing diacyl peroxides can be formulated to provide improved stain removal performance on plastics while minimizing deposition. This is achieved using small diacyl peroxide particles having a size of from about 0.1 to about 30 microns. While larger particles provide stain removal benefits, they often leave a residue (white film) on substrates, which is unacceptable for consumers. The compositions herein are effective at removing stains, especially fruit juice and carotenoid stains, from plastic dishware and interior surfaces of automatic dishwashing machines without leaving consumer noticeable residue or film on dishware. The compositions thus provide cleaning and spotting/filming advantages over prior art compositions. The compositions of the present invention also are effective for deodorizing and disinfecting surfaces encountered in automatic dishwashing machine processes.

### SUMMARY OF THE INVENTION

The present invention encompasses stable liquid or gel bleaching compositions, especially thixotropic gel compositions for use in automatic dishwashing machines, comprising, by weight:

(a) from about 0.1% to about 5% of diacyl peroxide particles having a particle size of from about 0.1 to about 30 microns, said diacyl peroxide having the general formula:

RC(O)OO(O)CR

wherein each R is a hydrocarbyl group;

(b) from about 0.1% to about 5% of a thickener; and

(c) from about 80% to about 99% of water;

wherein said composition has a pH of from about 2 to about 10.

The present invention also encompasses a method for cleaning plastic surfaces in an automatic dishwashing machine while minimizing deposition, comprising contacting said surfaces with an aqueous wash liquor comprising from about 10 ppm to about 300 ppm of said diacyl peroxide particles.

### DETAILED DESCRIPTION OF THE INVENTION

The stable liquid or gel bleaching compositions of the invention comprises diacyl peroxide particles, thickener, and water, as described hereinafter.

Diacyl Peroxide Bleach Particles

The composition of the present invention contain from about 0.1% to about 5%, preferably from about 0.3% to about 4%, more preferably from about 0.5% to about 3%, and most preferably from about 0.7% to about 2%, of diacyl peroxide of the general formula:

RC(O)OO(O)CR

wherein each R, independently, is a hydrocarbyl group. Each R can be an alkyl, aryl, heterocyclic, imino, amino, or floro group. Preferably no more than one R is a hydrocarbyl chain of longer than ten carbon atoms, more preferably at least one has an aromatic nucleus.

The preferred diacyl peroxides have a melting point greater than about 30° C., preferably greater than about 50° C., most preferably above 70° C.

The diacyl peroxide should be present in the form of insoluble or relatively insoluble particles having a particle size of from about 0.1 to about 30 microns, preferably from about 0.5 to about 20 microns, more preferably from about 1 to about 10 microns. Preferably, at least about 25%, more preferably at least 50%, even more preferably at least 75%, most preferably at least about 90%, of the particles are smaller than 10 microns, preferably smaller than 6 microns. Compositions having larger size diacyl peroxide particles are more difficult to stabilize, particularly during storage for longer periods of time, and often result in increased deposition and filming on dishware during use in automatic dishwashing machines. Diacyl peroxides within the above particle size range have also been found to provide better stain removal from plastic dishware, while minimizing undesirable deposition and filming, than larger diacyl peroxide particles. The preferred diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process.

Examples of suitable diacyl peroxides include dibenzoyl peroxide, benzoyl lauryl peroxide, benzoyl succinyl peroxide, di-(2-methybenzoyl) peroxide, diphthaloyl peroxide, and mixtures thereof. Preferably, the diacyl peroxide is selected from dibenzoyl peroxide, dicumyl peroxide, diphthaloyl peroxide, and mixtures thereof. A particulary preferred diacyl peroxide is dibenzoyl peroxide.

Thickener

Suitable thickening agents include the viscoelastic, thixotropic thickening agents. The thickening agent is used at a level of from about 0.1% to about 5%, preferably from about 0.2% to about 3%, most preferably from about 0.3% to about 2%, by weight of the composition. The type and level of thickener should be selected to provide the desired product thickness and stability, while minimizing undesired properties such as deposition and filming on plastic surfaces.

Preferably, the thickening agent is a polymer with a molecular weight of at least about 500,000, preferably from about 500,000 to 10,000,000. The polymeric thickening agent can be, but is not limited to, a cross-linked polycarboxylate polymer.

The cross-linked polycarboxylate polymer is preferably a carboxyvinyl polymer. Such compounds are disclosed in U.S. Pat. No. 2,798,053, Brown, issued on Jul. 2, 1957, incorporated herein by reference. Methods for making carboxyvinyl polymers are also disclosed in Brown. Carboxyvinyl polymers are substantially insoluble in liquid, volatile organic hydrocarbons and are dimensionally stable on exposure to air.

Various carboxyvinyl polymers, homopolymers and copolymers are commercially available from B. F. Goodrich Company, New York, N.Y., under the trade name Carbopol®. These polymers are also known as carbomers or polyacrylic acids. Carboxyvinyl polymers useful in formulations of the present invention include Carbopol 910 having a molecular weight of about 750,000, Carbopol 941 having a molecular weight of about 1,250,000, and Carbopols 934 and 940 having molecular weights of about 3,000,000 and 4,000,000, respectively. More preferred are the series of Carbopols, which use ethyl acetate and cyclohexane in the manufacturing process, for example, Carbopol 981, 984, 980, and 1382, and their easy-to-disperse equivalents such as Carbopol ETD2001, ETD2050, and ETD2020.

Preferred polycarboxylate polymers of the invention are non-linear, water-dispersible, polyacrylic acid cross-linked with a polyalkenyl polyether and having a molecular weight of at lease 750,000, preferably from about 750,000 to about 4,000,000.

Highly preferred examples of these polycarboxylate polymers for use in the present invention are Sokalan PHC-25®, a polyacrylic acid available from BASF Corporation, the Carbopol series resins available from B. F. Goodrich, and the Polygel series available from 3-V Chemical Corporation. Mixtures of polycarboxylate polymers as herein described may also be used.

The polycarboxylate polymer-thickening agent can be used alone or with inorganic clays (e.g. aluminum silicate, bentonite, fumed silica). The preferred clay-thickening agent can be either naturally occurring or synthetic. A preferred synthetic clay is the one disclosed in the U.S. Pat. No. 3,843,598, incorporated herein by reference. Naturally occurring clays include some smectite and attapulgite clays as disclosed in U.S. Pat. No. 4,824,590, incorporated herein by reference.

Other types of thickeners, which can be used in this composition, include natural gums, such as xanthan gum, locust bean gum, guar gum, and the like. Semi-synthetic thickeners such as the cellulosic type thickeners: hydroxyethyl and hydroxymethyl cellulose (ETHOCEL and METHOCEL® available from Dow Chemical) can also be used. Mixtures of polymeric thickening agents, semi-synthetic, and natural thickeners herein described may also be used.

In the preferred liquid automatic dishwashing detergent composition, the polycarboxylate polymer thickening agent provides an apparent viscosity at high shear of greater than about 400 centipoise and an apparent yield value of from about 40 to about 800, and most preferably from about 60 to about 600, dynes/cm² to the composition.

Viscosity is a measure of the internal resistance to flow exhibited by a fluid in terms of the ratio of the shear stress to the shear rate. The yield value is an indication of the shear stress at which the gel strength is exceeded and flow is initiated. Yield value can be measured herein with a Brookfield RVT model viscometer with a T-bar B spindle at about 77° F. (25° C.) utilizing the Helipath drive during associated readings. The system is set to 0.5 rpm and a torque reading is taken for the composition to be tested after 30 seconds or after the system is stable. The system is stopped and the rpm is reset to 1.0 rpm. A torque reading is taken from the same composition after 30 seconds or after the system is stable. Apparent viscosities are calculated from the torque readings using factors provided with the Brookfield viscometer. An apparent Brookfield yield value is then calculated as: Brookfield Yield Value—(apparent viscosity at 0.5 rpm—apparent viscosity at 1 rpm)/100. This is the common method of calculation, published in Carbopol literature from the B. F. Goodrich Company and in other published references. In the cases of most of the formulations quoted herein, this apparent yield value is approximately four times higher than yield values calculated from shear rate and shear stress measurements in more rigorous Theological equipment.

Apparent viscosities at high shear are determined with a Brookfield RVT viscometer with spindle #6 at 100 rpm, reading the torque at 30 seconds.

A preferred method herein for measuring viscosity and yield value is with a Contraves Rheomat 115 viscometer, which utilizes a Rheoscan 100 controller, a DIN 125 spindle and cup at 25° C. For viscosity measurements, the shear rate is increased from 0 to 150 sec⁻¹ over a 30 second time period. The viscosity, measured in centipoise, is taken at a shear rate of 150 sec⁻¹. The shear rate for yield value measurements is increased linearly from 0 to 0.4 sec⁻¹ over a period of 60 seconds after an initial 5 second rest period.

Water

The compositions of the present invention contain from about 80% to about 99%, preferably from about 85% to about 99%, more preferably from about 90% to about 99%, and most preferably from about 95% to about 99%, by weight of water.

The compositions may also contain minor amounts of solvents in which the diacyl peroxide will not dissolve. Suitable solvents useful herein are glycerol, dimethyl siloxanes, sorbitol, and mixtures thereof. If present, such solvents represent less than about 20%, preferably less than about 10%, most preferably less than about 5%, by weight of the composition.

The compositions herein should not contain significant amounts of solvents capable of dissolving the diacyl peroxides herein. Examples of such solvernts are N-alkyl pyrrolidones, such as N-ethyl pyrrolidone, diacetone alcohol, alkyl ethers, cyclic alkyl ketones, and mixtures thereof. Amines, ethers and low molecular weight primary and secondary alcohols (about C₁-C₆) also are preferably not present, since it is believed that they may introduce stability problems. Preferably, the compositions herein contain no more than about 5% by weight of such solvents. More preferably, the compositions contain no more than about 2% by weight of such solvents. Most preferably, they are substantially free of such solvents.

Composition pH

The compositions herein have a pH, measured at a concentration of 1% by weight in water, of from 2 to about 10, preferably from about 3 to about 9, more preferably from about 4 to about 8, and most preferably from about 5 to about 7. At higher pHs, the diacyl peroxide particles are degraded and stain removal performance is reduced, particularly in the presence of agents that solubilize the diacyl peroxide such as surfactants.

The compositions may thus comprise a pH-adjusting component selected from water-soluble alkaline inorganic salts and water-soluble organic or inorganic builders. Preferred pH-adjusting components are selected from the group consisting of: sodium/potassium carbonate or sesquicarbonate; sodium/potassium silicate, preferably hydrous sodium silicate having SiO₂:Na₂O ratio of from about 1.:1 to about 2:1; sodium/potassium citrate; citric acid; sodium/potassium bicarbonate; sodium/potassium borate, preferably borax; and sodium/potassium hydroxide; and mixtures thereof.

Alkali metal silicates also provide protection against corrosion of metals and inhibit corrosion of glasswares and chinawares, as described in EP 717,102, published Jun. 19, 1996, incorporated herein by reference. However, the silicate type and level must be selected such that the pH stays within the desired pH range.

The pH-adjusting system can be complemented (e.g., for improved sequestration in hard water) by other optional detergency builder salts selected from phosphate or nonphosphate detergency builders known in the art, which include the various water-soluble, alkali metal, ammonium or substituted ammonium borates, hydroxysulfonates, polyacetates, and polycarboxylates. Preferred is the alkali metal, especially sodium, salts of such materials. Alternate water-soluble, non-phosphorus organic builders can be used for their sequestering properties. Examples of polyacetate and polycarboxylate builders are the sodium, potassium, lithium, ammonium and substituted ammonium salts of ethylenediamine tetraacetic acid, ethylenediamine disuccinic acid (especially the S,S-form); nitrilotriacetic acid, tartrate monosuccinic acid, tartrate disuccinic acid, oxydisuccinic acid, carboxymethyloxysuccinic acid, and mellitic acid, and sodium benzene polycarboxylate salts. Water insoluble builder like zeolites can also be used as builders.

Optional Ingredients

The compositions of the present invention may also contain various ingredients known for use in bleaching compositions, particularly compositions for use in automatic dishwashing machines. Generally, the compositions herein contain from about 0.01% to about 20%, preferably from about 0.1% to about 15%, more preferably from about 0.5% to about 10%, by weight, of such optional ingredients.

Heavy metal ion sequestrants (chelants) are useful components herein. These components may also have calcium and magnesium chelation capacity, but preferentially bind heavy metal ions such as iron, manganese and copper. If present, the heavy metal ion sequestrant is preferably used at a level of from 0.005% to 5%, more preferably from 0.05% to 1%, by weight of the composition.

Heavy metal ion sequestrants, which are acidic in nature, having for example phosphonic acid or carboxylic acid functionalities, may be present either in their acid form or as a complex/salt with a suitable counter cation such as an alkali or alkaline metal ion, ammonium, or substituted ammonium ion, or any mixtures thereof. Preferably any salts/complexes are water-soluble. The molar ratio of said counter cation to the heavy metal ion sequestrant is preferably at least 1:1.

Suitable heavy metal ion sequestrants for use herein include the organo aminophosphonates, such as the amino alkylene poly (alkylene phosphonates) and nitrilo trimethylene phosphonates. Preferred organo aminophosphonates are diethylene triamine penta (methylene phosphonate) and hexamethylene diamine tetra (methylene phosphonate).

Other suitable heavy metal ion sequestrants for use herein include nitrilotriacetic acid and polyaminocarboxylic acids such as ethylenediaminotetracetic acid, ethylenetriamine pentacetic acid, or ethylenediamine disuccinic acid. Especially preferred is ethylenediamine-N,N′-disuccinic acid (EDDS), most preferably present in the form of its S,S isomer, which is preferred for its biodegradability profile.

Still other suitable heavy metal ion sequestrants for use herein are iminodiacetic acid derivatives such as 20 hydroxyethyl diacetic acid or glyceryl imino diacetic acid.

A preferred chelant is an organo diphosphonic acid or one of its salts/complexes. The organo diphosphonic acid is preferably a C₁-C₄ diphosphonic acid, more preferably a C2 diphosphonic acid, such as ethylene diphosphonic acid, or most preferably ethane 1-hydroxy-1,1-diphosphonic acid (HEDP).

Other Optional Bleaches

The compositions of the present invention can additionally contain an additional amount of oxygen bleach or chlorine bleach.

The oxygen bleach should be sufficient to provide from 0.01% to about 8%, preferably from about 0.1% to about 5.0%, more preferably from about 0.3% to about 4.0%, most preferably from about 0.8% to about 3% of available oxygen (AvO) by weight of the composition.

Available oxygen of a bleach component is the equivalent bleaching oxygen content thereof expressed as % AvO. For example, commercially available sodium perborate monohydrate typically has an available oxygen content for bleaching purposes of about 15% (theory predicts a maximum of about 16%). Methods for determining available oxygen of a formula after manufacture share similar chemical principles but depend on whether the oxygen bleach incorporated therein is a simple hydrogen peroxide source such as sodium perborate or percarbonate, is an activated type (e.g., perborate with tetra-acetyl ethylenediamine) or comprises a preformed peracid such as monoperphthalic acid. Analysis of peroxygen compounds is well-known in the art: see, for example, the publications of Swern, such as “Organic Peroxides”, Vol. I, D. H. Swern, Editor; Wiley, New York, 1970, LC # 72-84965, incorporated by reference. See for example the calculation of “percent active oxygen” at page 499. This term is equivalent to the terms “available oxygen” or “percent available oxygen” as used herein.

The peroxygen bleaching systems useful herein are those capable of yielding hydrogen peroxide in an aqueous liquor. These compounds include, but are not limited to, hydrogen peroxide, the alkali metal peroxides, organic peroxide bleaching compounds such as urea peroxide and inorganic persalt bleaching compounds such as the alkali metal perborates, percarbonates, perphosphates, and the like. Mixtures of two or more such bleaching compounds can also be used.

Preferred peroxygen bleaching compounds include sodium perborate, commercially available in the form of mono-, tri-, and tetra-hydrate, sodium pyrophosphate peroxyhydrate, urea peroxyhydrate, sodium percarbonate, and sodium peroxide. Particularly preferred are sodium perborate tetrahydrate, sodium perborate monohydrate and sodium percarbonate. Percarbonate is especially preferred because of environmental issues associated with boron.

Suitable oxygen-type bleaches are further described in U.S. Pat. No. 4,412,934 (Chung et al), issued Nov. 1, 1983, and peroxyacid bleaches described in European Patent Application 033,259, Sagel et al, published Sep. 13, 1989, both incorporated herein by reference, can be used.

The optional peroxygen bleach component may be formulated with an activator (peracid precursor). The activator is present at levels of from about 0.01% to about 5%, preferably from about 0.1% to about 4%, more preferably from about 0.5% to about 2%, by weight of the composition. Preferred activators are selected from the group consisting of benzoylcaprolactam (BzCL), 4-nitrobenzoylcaprolactam, 3-chlorobenzoylcaprolactam, benzoyloxybenzenesulphonate (BOBS), nonanoyloxybenzenesulphonate (NOBS), phenylbenzoate (PhBz), decanoyloxybenzenesulphonate (C₁₀-OBS), benzolyvalerolactam (BZVL), octanoyloxybenzenesulphonate (C₈-OBS), perhydrolyzable esters and mixtures thereof, most preferably benzoylcaprolactam and benzolyvalerolactam. Preferred bleach activators are those described in U.S. Pat. Nos. 5,130,045, Mitchell et al, and 4,412,934, Chung et al, and in U.S. Pat. Nos. 5,998,350 and 5,686,401, and EP 699,230, all of which are incorporated herein by reference.

The mole ratio of peroxygen bleaching compound (as AvO) to bleach activator in the present invention generally ranges from at least 1:1, preferably from about 20:1 to about 1:1, more preferably from about 10:1 to about 3:1.

The compositions of the present invention may also contain a bleach catalyst material, such as disclosed in U.S. Pat. Nos. 4,430,243; 5,246,621; 5,244,594; 4,246,612; 5,227,084; 5,194,416; 5,114,606; and 5,114,611.

Other bleach catalysts are described, for example, in European patent application publication no. 408,131 (cobalt complex catalysts), European patent application publication nos. 384,503 and 306,089 (metallo-porphyrin catalysts), U.S. Pat. No. 4,728,455 (manganese/multidentate ligand catalyst), U.S. Pat. No. 4,711,748 and European patent application publication no. 224,952 (absorbed manganese on aluminosilicate catalyst), U.S. Pat. No. 4,601,845 (aluminosilicate support with manganese and zinc or magnesium salt), U.S. Pat. No. 4,626,373 (manganese/ligand catalyst), U.S. Pat. No. 4,119,557 (ferric complex catalyst), German Pat. specification 2,054,019 (cobalt chelant catalyst), Canadian 866,191 (transition metal-containing salts), U.S. Pat. No. 4,430,243 (chelants with manganese cations and non-catalytic metal cations), and U.S. Pat. No. 4,728,455 (manganese gluconate catalysts).

Surfactant

Compositions of the present invention can comprise detergent surfactants, provided the surfactant type and level are selected to maintain the desired diacyl peroxide particle size. Low foaming nonionic surfactants (LFNIs) are preferred, and can be present in amounts from 0.1% to about 15% by weight, preferably from about 0.25% to about 10%, most preferably from about 0.5% to about 5%. LFNIs are most typically used to provide the improved water-sheeting action (especially from glass), which they confer to the product. They also encompass non-silicone, phosphate or nonphosphate polymeric materials further illustrated hereinafter which are known to defoam food soils encountered in automatic dishwashing.

Preferred LFNIs include nonionic alkoxylated surfactants, especially ethoxylates derived from primary alcohols, and blends thereof with more sophisticated surfactants, such as the polyoxypropylene/polyoxyethylene/polyoxypropylene reverse block polymers. The PO/EO/PO polymer-type surfactants are well-known to have foam suppressing or defoaming action, especially in relation to common food soil ingredients such as egg.

In a preferred embodiment, the LFNI is an ethoxylated surfactant derived from the reaction of a monohydroxy alcohol or alkylphenol containing from about 8 to about 20 carbon atoms, excluding cyclic carbon atoms, with from about 6 to about 15 moles of ethylene oxide per mole of alcohol or alkyl phenol on an average basis.

A particularly preferred LFNI is derived from a straight chain fatty alcohol containing from about 16 to about 20 carbon atoms (C₁₆-C₂₀ alcohol), preferably a C₁₈ alcohol, condensed with an average of from about 6 to about 15 moles, preferably from about 7 to about 12 moles, and most preferably from about 7 to about 9 moles of ethylene oxide per mole of alcohol. Preferably the ethoxylated nonionic surfactant so derived has a narrow ethoxylate distribution relative to the average.

The LFNI can optionally contain propylene oxide in an amount up to about 15% by weight. Other preferred LFNI surfactants can be prepared by the processes described in U.S. Pat. No. 4,223,163, issued Sep. 16, 1980, Builloty, incorporated herein by reference.

Preferred compositions herein containing the LFNI make use of ethoxylated monohydroxy alcohol or alkyl phenol and additionally comprise a polyoxyethylene, polyoxypropylene block polymeric compound; the ethoxylated monohydroxy alcohol or alkyl phenol fraction of the LFNI comprising from about 20% to about 80%, preferably from about 30% to about 70%, of the total LFNI.

Suitable block polyoxyethylene-polyoxypropylene polymeric compounds that meet the requirements described herein before include those based on ethylene glycol, propylene glycol, glycerol, trimethylolpropane and ethylenediamine as initiator reactive hydrogen compound. Polymeric compounds made from a sequential ethoxylation and propoxylation of initiator compounds with a single reactive hydrogen atom, such as C₁₂-18 aliphatic alcohols, do not generally provide satisfactory suds control in the instant compositions. Certain of the block polymer surfactant compounds designated PLURONIC® and TETRONIC® by the BASF-Wyandotte Corp., Wyandotte, Mich., are suitable in compositions of the invention.

A particularly preferred LFNI contains from about 40% to about 70% of a polyoxypropylene/polyoxyethylene/polyoxypropylene block polymer blend comprising about 75%, by weight of the blend, of a reverse block co-polymer of polyoxyethylene and polyoxypropylene containing 17 moles of ethylene oxide and 44 moles of propylene oxide; and about 25%, by weight of the blend, of a block co-polymer of polyoxyethylene and polyoxypropylene initiated with trimethylolpropane and containing 99 moles of propylene oxide and 24 moles of ethylene oxide per mole of trimethylolpropane.

Suitable for use as LFNI in the compositions are those LFNI having relatively low cloud points and high hydrophilic-lipophilic balance (HLB). Cloud points of 1% solutions in water are typically below about 32° C. and preferably lower, e.g., 0° C., for optimum control of sudsing throughout a full range of water temperatures.

LFNIs, which may also be used, include a C₁₈ alcohol polyethoxylate, having a degree of ethoxylation of about 8, commercially available SLF18 from Olin Corp. and any biodegradable LFNI having the cloud point properties discussed herein above.

The compositions herein can additionally contain an anionic surfactant, in an amount from 0 to about 5%, preferably from about 0.1% to about 3%, more preferably from about 0.25% to about 1%, by weight of the composition.

Suitable anionic surfactants include branched or linear alkyl sulfates and sulfonates. These may contain from about 8 to about 20 carbon atoms. Other anionic surfactants include the alkyl benzene sulfonates containing from about 6 to about 13 carbon atoms in the alkyl group, and mono- and/or dialkyl phenyl oxide mono- and/or di-sulfonates wherein the alkyl groups contain from about 6 to about 16 carbon atoms. All of these anionic co-surfactants are used as stable salts, preferably sodium and/or potassium.

Preferred anionic surfactants include sulfobetaines, betaines, alkyl(polyethoxy)sulfates (AES) and alkyl (polyethoxy)carboxylates, which are usually high sudsing. Optional anionic surfactants are further illustrated in published British Patent Application No. 2,116,199A; U.S. Pat. No. 4,005,027, Hartman; U.S. Pat. No. 4,116,851, Rupe et al; and U.S. Pat. No. 4,116,849, Leikhim, all of which are incorporated herein by reference.

Preferred alkyl(polyethoxy)sulfate surfactants comprise a primary alkyl ethoxy sulfate derived from the condensation product of a C₆-C₁₈ alcohol with an average of from about 0.5 to about 20, preferably from about 0.5 to about 5, ethylene oxide groups. The C₆-C₁₈ alcohol itself is preferable commercially available. C₁₂-C₁₅ alkyl sulfate, which has been ethoxylated with from about 1 to about 5 moles of ethylene oxide per molecule, is preferred. Where the compositions of the invention are formulated to have a pH of between 6.5 to 9.3, preferably between 8.0 to 9, wherein the pH is defined herein to be the pH of a 1% solution of the composition measured at 20° C., surprisingly robust soil removal, particularly proteolytic soil removal, is obtained when C₁₀-C₁₈ alkyl ethoxysulfate surfactant, with an average degree of ethoxylation of from 0.5 to 5 is incorporated into the composition in combination with a proteolytic enzyme, such as neutral or alkaline proteases at a level of active enzyme of from 0.005% to 2%. Preferred alkyl(polyethoxy)sulfate surfactants for inclusion in the present invention are the C₁₂-C₁₅ alkyl ethoxysulfate surfactants with an average degree of ethoxylation of from 1 to 5, preferably 2 to 4, most preferably 3.

Conventional base-catalyzed ethoxylation processes to produce an average degree of ethoxylation of 12 result in a distribution of individual ethoxylates ranging from 1 to 15 ethoxy groups per mole of alcohol, so that the desired average can be obtained in a variety of ways. Blends can be made of material having different degrees of ethoxylation and/or different ethoxylate distributions arising from the specific ethoxylation techniques employed and subsequent processing steps such as distillation.

Alkyl(polyethoxy)carboxylates suitable for use herein include those with the formula RO(CH₂CH₂O)ₓCH₂COO—M⁺ wherein R is a C₆ to C₁₈ alkyl group, x ranges from 0 to 10, and the ethoxylate distribution is such that, on a weight basis, the amount of material where x is 0 is less than about 20%, preferably less than about 15%, most preferably less than about 10%, and the amount of material where x is greater than 7, is less than about 25%, preferably less than about 15%, most preferably less than about 10%, the average x is from about 2 to 4 when the average R is C₁₃ or less, and the average x is from about 3 to 6 when the average R is greater than C₁₃, and M is a cation, preferably chosen from alkali metal, alkaline earth metal, ammonium, mono-, di-, and tri-ethanol-ammonium, most preferably from sodium, potassium, ammonium and mixtures thereof with magnesium ions. The preferred alkyl(polyethoxy)carboxylates are those where R is a C₁₂ to C₁₈ alkyl group.

Preferred anionic surfactants herein are sodium or potassium salt-forms for which the corresponding calcium salt form has a low Kraft temperature, e.g., 30° C. or below, or, even better, 20° C. or lower. Examples of such highly preferred anionic surfactants are the alkyl(polyethoxy)sulfates.

The preferred anionic surfactants of the invention in combination with the other components of the composition provide excellent cleaning and outstanding performance from the standpoints of residual spotting and filming. However, many of these co-surfactants may also be high sudsing thereby requiring the addition of LFNI, LFNI in combination with alternate suds suppressors as further disclosed hereinafter, or alternate suds suppressors without conventional LFNI components.

The compositions of the invention can optionally contain an alkyl phosphate ester suds suppressor, a silicone suds suppressor, or combinations thereof. Levels in general are from 0% to about 3%, preferably from about 0.001% to about 2%. Typical levels tend to be low, e.g., from about 0.01% to about 1% when a silicone suds suppressor is used. Preferred non-phosphate compositions omit the phosphate ester component entirely.

It is preferable to avoid the use of simple calcium-precipitating soaps as antifoams in the present compositions as they tend to deposit on the dishware. Indeed, phosphate esters are not entirely free of such problems and the formulator will generally choose to minimize the content of potentially depositing antifoams in the instant compositions.

Compositions herein may additionally contain a dispersant polymer. Dispersant polymers are generally compatible with the diacyl peroxide (i.e. do not solubilize the diacyl peroxide) and typically are used at levels up to about 10%, preferably from about 0.1% to about 6%, more preferably from about 0.2% to about 4% by weight of the composition. Dispersant polymers are useful for improved filming performance of the present compositions, especially in higher pH embodiments, such as those in which pH exceeds about 9.5. Particularly preferred are polymers, which inhibit the deposition of calcium carbonate or magnesium silicate on dishware.

Dispersant polymers suitable for use herein are illustrated by the film-forming polymers described in U.S. Pat. No. 4,379,080 (Murphy), issued Apr. 5, 1983, incorporated herein by reference.

Suitable polymers are preferably at least partially neutralized or alkali metal, ammonium or substituted ammonium (e.g., mono-, di- or triethanolammonium) salts of polycarboxylic acids. The alkali metal, especially sodium salts are most preferred. While the molecular weight of the polymer can vary over a wide range, it preferably is from about 1000 to about 500,000, more preferably is from about 1000 to about 250,000, and most preferably, from about 1000 to about 5,000.

Other suitable dispersant polymers include those disclosed in U.S. Pat. No. 3,308,067 issued Mar. 7, 1967, to Diehl, incorporated herein by reference. Unsaturated monomeric acids that can be polymerized to form suitable dispersant polymers include acrylic acid, maleic acid (or maleic anhydride), fumaric acid, itaconic acid, aconitic acid, mesaconic acid, citraconic acid and methylenemalonic acid. The presence of monomeric segments containing no carboxylate radicals such as methyl vinyl ether, styrene, ethylene, etc. is suitable provided that such segments do not constitute more than about 50% by weight of the dispersant polymer.

Copolymers of acrylamide and acrylate having a molecular weight of from about 3,000 to about 100,000, preferably from about 4,000 to about 20,000, and an acrylamide content of less than about 50%, preferably less than about 20%, by weight of the dispersant polymer can also be used. Most preferably, such dispersant polymer has a molecular weight of from about 4,000 to about 20,000 and an acrylamide content of from about 0% to about 15%, by weight of the polymer.

Particularly preferred dispersant polymers are low molecular weight modified polyacrylate copolymers. Such copolymers contain as monomer units: a) from about 90% to about 10%, preferably from about 80% to about 20% by weight acrylic acid or its salts and b) from about 10% to about 90%, preferably from about 20% to about 80% by weight of a substituted acrylic monomer or its salt and have the general formula: —[(C(R²)C(R¹)(C(O)OR³)]— wherein the incomplete valencies inside the square braces are hydrogen and at least one of the substituents R¹, R² or R³, preferably R¹ or R², is a 1 to 4 carbon alkyl or hydroxyalkyl group, R¹ or R² can be a hydrogen and R³ can be a hydrogen or alkali metal salt. Most preferred is a substituted acrylic monomer wherein R¹ is methyl, R² is hydrogen and R³ is sodium.

The low molecular weight polyacrylate dispersant polymer preferably has a molecular weight of less than about 15,000, preferably from about 500 to about 10,000, most preferably from about 1,000 to about 5,000. The most preferred polyacrylate copolymer for use herein has a molecular weight of 3500 and is the fully neutralized form of the polymer comprising about 70% by weight acrylic acid and about 30% by weight methacrylic acid.

Other suitable modified polyacrylate copolymers include the low molecular weight copolymers of unsaturated aliphatic carboxylic acids disclosed in U.S. Pat. Nos. 4,530,766, and 5,084,535, both incorporated herein by reference.

Preferred polymers also include polyacrylates with an average molecular weight of from about 1,000 to about 10,000, and acrylate/maleate or acrylate/fumarate copolymers with an average molecular weight of from about 2,000 to about 80,000 and a ratio of acrylate to maleate or fumarate segments of from about 30:1 to about 1:2. Examples of such copolymers based on a mixture of unsaturated mono- and dicarboxylate monomers are disclosed in European Patent Application No. 66,915, published Dec. 15, 1982, incorporated herein by reference.

Other dispersant polymers useful herein include the polyethylene glycols and polypropylene glycols having a molecular weight of from about 950 to about 30,000, which can be obtained from the Dow Chemical Company of Midland, Mich. Such compounds for example, having a melting point within the range of from about 30 to about 100 C can be obtained at molecular weights of 1450, 3400, 4500, 6000, 7400, 9500, and 20,000. Such compounds are formed by the polymerization of ethylene glycol or propylene glycol with the requisite number of moles of ethylene or propylene oxide to provide the desired molecular weight and melting point. The polyethylene, polypropylene and mixed glycols are referred to using the formula HO(CH₂CH₂O)ₘ(CH₂CH(CH₃)O)ₙ(CH(CH₃)CH₂O)OH wherein m, n, and o are integers satisfying the molecular weight and temperature requirements given above.

Yet other dispersant polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate is the most preferred polymer of this group.

Other suitable dispersant polymers are the carboxylated polysaccharides, particularly starches, celluloses and alginates, described in U.S. Pat. No. 3,723,322, Diehl, issued Mar. 27, 1973; the dextrin esters of polycarboxylic acids disclosed in U.S. Pat. No. 3,929,107, Thompson, issued Nov. 11, 1975; the hydroxyalkyl starch ethers, starch esters, oxidized starches, dextrins and starch hydrolysates described in U.S. Pat. No. 3,803,285, Jensen, issued Apr. 9, 1974; the carboxylated starches described in U.S. Pat. No. 3,629,121, Eldib, issued Dec. 21, 1971; and the dextrin starches described in U.S. Pat. No. 4,141,841, McDanald, issued Feb. 27, 1979; all incorporated herein by reference. Preferred cellulose-derived dispersant polymers are the carboxymethyl celluloses.

Yet another group of acceptable dispersants are the organic dispersant polymers, such as polyaspartate.

The present compositions may also contain corrosion inhibitor. Such corrosion inhibitors are preferred components of machine dishwashing compositions in accord with the invention, and are preferably incorporated at a level of from 0.05% to 10%, preferably from 0.1% to 5% by weight of the total composition.

Suitable corrosion inhibitors include paraffin oil typically a predominantly branched aliphatic hydrocarbon having a number of carbon atoms in the range of from 20 to 50. Preferred paraffin oil is selected from the predominantly branched C₂₅₋₄₅ species with a ratio of cyclic to noncyclic hydrocarbons of about 32:68. A paraffin oil meeting these characteristics is sold by Wintershall, Salzbergen, Germany, under the trade name WINOG 70.

Other suitable corrosion inhibitor compounds include benzotriazole and any derivatives thereof, mercaptans and diols, especially mercaptans with 4 to 20 carbon atoms including lauryl mercaptan, thiophenol, thionapthol, thionalide and thioanthranol. Also suitable are the C₁₂-C₂₀ fatty acids, or their salts, especially aluminum tristearate. The C₁₂-C₂₀ hydroxy fatty acids, or their salts, are also suitable. Phosphonated octa-decane and other anti-oxidants such as betahydroxytoluene (BHT) are also suitable.

Hydrotrope materials such as sodium benzene sulfonate, sodium toluene sulfonate, sodium cumene sulfonate, etc., can be present in minor amounts.

Bleach-stable perfumes (stable as to odor); and bleach-stable dyes (such as those disclosed in U.S. Pat. No. 4,714,562, Roselle et al, issued Dec. 22, 1987); can also be added to the present compositions in appropriate amounts.

Preferred perfumes for use in the present compositions are disclosed in U.S. Pat. No. 6,143,707, Trinh et al., incorporated herein by reference. A particularly preferred perfume for use herein is the following Perfume A.

PERFUME A

| Perfume Ingredients | Wt. % |
|---|---|
| Blooming Ingredients | |
| Citronellyl Acetate | 1.00 |
| Delta Damascone | 0.15 |
| Geranyl Nitrile | 5.25 |
| Ionone Beta | 12.00 |
| d-Limonene | 3.65 |
| Methyl Nonyl Acetaldehyde | 2.00 |
| Undecavertol | 0.25 |
| Verdox | 0.30 |
| Vertenex | 8.95 |
| | (33.55%) |
| Delayed Blooming Ingredients | |
| Allyl Amyl Glycolate | 1.30 |
| Benzyl Acetone | 1.00 |
| Beta Gamma Hexenol | 0.05 |
| Cis-3-Hexenyl Acetate | 0.20 |
| Dimethyl Benzyl Carbinyl Acetate | 2.50 |
| Ethyl Maltol | 0.05 |
| Ethyl-2-methyl Butyrate | 0.30 |
| Ethyl-2-methyl Pentanoate | 0.25 |
| Eucalyptol | 0.63 |
| Flor Acetate | 2.25 |
| Frutene | 2.25 |
| Geraniol | 10.50 |
| Ligustral | 4.50 |
| Methyl Iso Butenyl Tetrahydro Pyran | 0.10 |
| Methyl Phenyl Carbinyl Acetate | 3.50 |
| Stemone | 0.30 |
| Terpineol | 1.00 |
| | (30.68%) |
| Base Masking Ingredients | |
| Florhydral | 0.25 |
| Habanolide 100% | 3.75 |
| Alpha-Hexylcinnamaldehyde | 10.55 |
| Iso E Super | 5.00 |
| Lilial | 2.50 |
| Nectaryl | 2.25 |
| Gamma-Undecalactone | 0.60 |
| | (24.90%) |
| Other Ingredients | |
| Methyl Dihydro Jasmonate | 9.87 |
| Para Hydroxy Phenyl Butanone | 0.60 |
| Vanillin | 0.40 |
| | (10.87%) |

Method for Cleaning

The present invention also encompasses a method for cleaning plastic surfaces in an automatic dishwashing machine while minimizing deposition, comprising contacting said surfaces with an aqueous wash liquor comprising from about 10 ppm to about 300 ppm of the above diacyl peroxide particles having a particle size of from about 0.1 to about 30 microns. The wash liquor preferably has a pH of from about 2 to about 11, preferably from about 2 to about 10, for good cleaning performance.

The diacyl peroxide particles in the wash liquor preferably have a particle size from about 0.5 to about 20 microns, more preferably from about 1 to about 10 microns, for best stain removal, while minimizing filming due to deposition of larger diacyl peroxide particles. Filming can also increase if the diacyl peroxide particles are solubilized, or if the concentration of the diacyl peroxide in the wash liquor exceeds about 300 ppm. In a preferred embodiment, the aqueous wash liquid comprises from about 20 to about 250 ppm, more preferably from about 50 to about 200 ppm, most preferably from about 50 to about 150 ppm, of the diacyl peroxide particles.

For compositions herein intended for cleaning dishwashing machines, where deposition of diacyl peroxide particles and filming are not noticeable to consumers, it will be appreciated that larger diacyl peroxides particles and higher levels thereof may be used, and the optional cleaning ingredients herein may be preferred.

The aqueous wash liquor is formed by dispersing the liquid or gel bleaching composition herein in a dishwashing machine. In a preferred embodiment, the bleaching composition herein is a thixotropic gel that is dispensed from the main wash dispensing cup of the automatic dishwashing machine. This provides adequate contact time for the diacyl peroxide particles to bleach and remove stains from plastic surfaces during the washing process. In contrast, dosing during the pre-wash does not allow enough active bleaching species to survive until the main wash for optimum performance. Alternatively, thicker products may be formulated that release an adequate amount of diacyl peroxide particles during the washing process, even when dispensed at the beginning of the process. For example, a thickened product can be dispensed from a tube or bottle onto the door (including in an open dispensing cup) or bottom of the machine, or directly onto stained dishware in the machine. The dishwashing machine can then be operated, with or without a fully formulated, automatic dishwashing detergent composition added to one or both dispensing cups. The products of the present invention can also be dosed from a device placed inside the machine, so long as there is adequate contact time between the diacyl peroxide particles and the surfaces to be bleached. However, dosing of the diacyl peroxide in the final rinse generally provides insufficient contact time for optimum bleaching performance.

Additionally, a package for the bleaching composition herein preferably is substantially impermeable to water, carbon dioxide, and light. Plastic bottles, including refillable or recyclable types, as well as conventional barrier cartons or boxes are generally suitable. When ingredients are not highly compatible, e.g., mixtures of silicates and citric acid, it may further be desirable to coat at least one such ingredient with a low-foaming nonionic surfactant for protection. There are numerous waxy materials, which can readily be used to form suitable coated particles of any such otherwise incompatible components.

The package preferably contains instructions on the use of the composition herein with the package containing the composition or with other forms of advertising associated with the sale or use of the composition. The instructions may be included in any manner typically used by consumer product manufacturing or supply companies. Examples include providing instructions on a label attached to the container holding the composition; on a sheet either attached to the container or accompanying it when purchased; or in advertisements, demonstrations, and/or other written or oral instructions which may be connected to the purchase or use of the composition. The instructions should guide the user on the optimum methods for using the composition herein, including preferred dosage levels to obtain the desired concentration of diacyl peroxide in the wash liquor, and the preferred contact time and wash liquor temperature for optimum performance. For preferred compositions herein, intended for use in bleaching and removing stains from plastic dishware, the instructions direct the user to fill the main wash dispensing cup of the automatic dishwashing machine and run the machine without adding their regular detergent. Other preferred compositions of the invention can be dispensed from the pre-wash dispensing cup, or as otherwise described above, particularly if they contain sufficient thickener to provide for release of at least a portion of the diacyl peroxide in the main cycle. Such compositions are preferably used in conjunction with a regular automatic dishwashing detergent composition. Other preferred compositions herein intended for use as a machine cleaning product to de-stain and clean plastic surfaces on the interior of an automatic dishwashing machine preferably include instructions for use thereof. For example, the instructions may direct the user to fill the main wash dispensing cup with the product and run the machine empty.

The following examples illustrate the compositions of the present invention. These examples are not meant to limit or otherwise define the scope of the invention. All parts, percentages and ratios used herein are expressed as percent weight unless otherwise specified.

### EXAMPLE I

Stable, liquid bleaching compositions of the present invention are as follows:

| | % by weight of active material | | | | | | |
|---|---|---|---|---|---|---|---|
| INGREDIENTS | A | B | C | D | E | F | G |
| Dibenzoyl Peroxide* | 0.9 | 3.6 | 3.0 | 0.5 | 1.5 | 0.9 | 1.8 |
| Carbopol 980 | 0.5 | 1.5 | 0.4 | 0.4 | 1.0 | 0.5 | 0.5 |
| Sodium Hydroxide | 0.07 | 0.3 | 0.1 | — | — | 0.1 | 0.14 |
| Nonionic surfactant | — | — | — | — | — | — | 5.0 |
| (SLF 18) | | | | | | | |
| Sodium Citrate | — | — | 10 | — | — | — | — |
| Na₂CO₃/K₂CO₃ | — | — | — | 1.0 | — | — | — |
| Sodium Silicate | — | — | — | — | 1.0 | — | — |
| (2.4 ratio) | | | | | | | |
| Dispersant | — | — | — | 4.0 | — | — | — |
| (Acusol 480N) | | | | | | | |
| Sorbitol | — | — | — | — | — | 6.0 | — |
| Perfume A | 0.125 | 0.125 | 0.15 | 0.15 | 0.15 | 0.15 | 0.125 |
| Water + | Balance to 100 | | | | | | |
| preservatives** | | | | | | | |
| pH (1% in water) | 6.0 | 6.5 | | | | | 6.5 |

*1-10 micron size particles, available as OxyCare50 ® (50% active) from ABCO Industries.
**100 ppm Neolone M-50 from Rohm & Haas, plus 0.15% Dantogard 2000 from Lonza.

The above compositions are made by slowly adding the Carbopol thickener to deionized water, allowing enough time for the Carbopol to become hydrated, and then adding the benzoyl peroxide, perfume and other ingredients, except caustic, to the mixture. The sodium hydroxide, citrate, carbonate or silicate is then slowly added to neutralize the Carbopol and thicken the product, with any nonionic surfactant added last. The resulting thixotropic gels are particularly useful for removing stains from plastic dishware, while minimizing deposition and filming on the dishware. Composition A is preferably squirted into the main wash dispensing cup of an automatic dishwashing machine, and used as a plastic cleaner in place of a regular automatic dishwashing detergent composition. Composition B is a thicker product that preferably is placed in the pre-wash dispensing cup and used with a regular automatic dishwashing detergent composition. Composition G is preferably a machine cleaning product that is squirted into the main wash dispensing cup prior to the machine being run empty.

What is claimed is:

1. A stable liquid or gel bleaching composition comprising, by weight:
a) from about 0.1% to about 5% of diacyl peroxide particles having a particle size of from about 0.1 to about 10 microns, said diacyl peroxide having the general formula:
RC(O)OO(O)CR
wherein each r is a hydrocarbyl group;
b) from about 0.1% to about 5% of thickener; and
c) from about 80% to about 99% of water;
wherein said composition has a pH of from about 2 to about 10; and wherein said composition is not granular.

2. A composition according to claim 1 wherein said diacyl peroxide is selected from the group consisting of dibenzoyl peroxide, benzoyl lauryl peroxide, benzoyl succinyl peroxide, di-(2-methybenzoyl) peroxide, diphthaloyl peroxide and mixtures thereof.

3. A composition according to claim 2 wherein said diacyl peroxide is dibenzoyl peroxide.

4. A composition according to claim 1 wherein said diacyl peroxide particles have a particle size of from about 0.1 to about 6 microns.

5. A composition according to claim 4 wherein said diacyl peroxide particles have a particle size of from about 0.1 to about 3 microns.

6. A composition according to claim 5 wherein said diacyl peroxide is dibenzoyl peroxide.

7. A composition according to claim 6 comprising from about 0.3% to about 4% of dibenzoyl peroxide.

8. A composition according to claim 7 comprising from about 90% to about 99% of water.

9. A composition according to claim 8 comprising from about 0.3% to about 2% of a cross-linked polycarboxylate polymer thickener.

10. A composition according to claim 1 having a pH of from about 3 to about 9.

11. A composition according to claim 9 having a pH of from about 5 to about 7.

12. A method for cleaning plastic surfaces in an automatic dishwashing machine while minimizing deposition, comprising:
a) dispersing a stable liquid or gel bleaching composition to form an aqueous wash liquor, said composition comprising by weight:
i) from about 0.1% to about 5% of diacyl peroxide particles;
ii) from about 0.1% to about 5% of thickener; and
iii) from about 80% to about 99% of water;
wherein said wash liquor has a pH of from about 2 to about 11; and
wherein said composition is not granular;
b) contacting said surfaces with said aqueous wash liquor comprising from about 10 ppm to about 300 ppm of diacyl peroxide particles having a particle size of from about 0.1 to about 10 microns, said diacyl peroxide having the general formula:
RC(O)OO(O)CR,
wherein each R is a hydrocarbyl group.

13. A method according to claim 12 wherein the wash liquor has a pH of from about 2 to about 10.

14. A method according to claim 12 wherein the wash liquor comprises from about 50 to about 200 ppm of the diacyl peroxide particles.

15. A method according to claim 12 wherein said diacyl peroxide is selected from the group consisting of dibenzoyl peroxide, benzoyl lauryl peroxide, benzoyl succinyl peroxide, di-(2-methybenzoyl) peroxide, diphthaloyl peroxide and mixtures thereof.

16. A method according to claim 15 wherein said diacyl peroxide is dibenzoyl peroxide.

17. A method according to claim 16 wherein said dibenzoyl peroxide particles have a particle size of from about 0.1 to about 6 microns.

18. A method according to claim 17 wherein the wash liquor comprises from about 50 to about 150 ppm of said dibenzoyl peroxide particles.
